(19) United States
(12) Patent Application Publication
(10) Pub. No.: US 2024/0172592 A1
(43) Pub. Date: May 30, 2024

(54) DEVICE AND METHOD FOR CULTIVATING AN AGRICULTURAL AREA

(71) Applicant: AI. Land GmbH, Kempen (DE)

(72) Inventor: Josef FRANKO, Kempen (DE)

(73) Assignee: AI. Land GmbH, Kempen (DE)

(21) Appl. No.: 18/432,613

(22) Filed: Feb. 5, 2024

Related U.S. Application Data
(63) Continuation of application No. PCT/DE2022/100562, filed on Aug. 3, 2022.

(30) Foreign Application Priority Data
Aug. 4, 2021 (DE) 10 2021 120 341.4

(51) Int. Cl. A01D 46/30; A01C 11/00; A01D 46/22

(52) U.S. Cl. CPC A01D 46/30; A01C 11/006; A01D 46/22

(57) ABSTRACT

An assembly and a method for management of an agricultural area. The assembly comprises at least an elongated truss and an associated chassis with at least one wheel with which the truss can be moved in a circular or linear manner over the arable area, and at least one cultivator which is attached to or provided on the truss by means of a robotic arm. The assembly also comprises a plurality of crates and a conveyor system provided on the truss along its longitudinal extension, wherein at least one crate is movable in a certain direction by the conveyor system along the longitudinal extension of the truss and can be brought to a predetermined position, in particular adjacent to a cultivator.

This nonprovisional application is a continuation of International Application No. PCT/DE2022/100562, which was filed on Aug. 3, 2022, and which claims priority to German Patent Application No. 10 2021 120 341.4, which was filed in Germany on Aug. 3, 2022, and which are both herein incorporated by reference.

### FIELD OF THE INVENTION

The present invention relates to an assembly for the management of an agricultural area and a corresponding method for which such an assembly can be used.

### DESCRIPTION OF THE BACKGROUND ART

According to the conventional art, an agricultural area can be managed with the aid of self-propelled machines. These machines can be autonomous mobile field robots that are equipped with their own chassis or underbody and have comparatively compact dimensions. Although such field robots can already be used with high precision, they are subject to the disadvantage of comparatively high costs, which makes cost-efficient use difficult. A further disadvantage arises from the fact that such autonomous or self-driving field robots are regarded as vehicles and in this respect there are strict restrictions on their use by the legislature in countries, such as Germany.

Self-propelled machines can also be equipped with gantry systems in the form of a truss, wherein a chassis with rollers is usually attached to both ends of the truss, so that the truss can be moved in a longitudinal direction over the ground or the agricultural area. For example, from AT 364659 B, an assembly for the management of an agricultural area with such a gantry system in the form of a bridge is known, which is moved perpendicular to its longitudinal extension by means of wheels running on rails. Along the bridge, a carriage can be moved in the longitudinal direction of the bridge, which serves as a tool carrier for a field cultivation device (e.g., for planting plants or weeding).

### SUMMARY OF THE INVENTION

It is therefore an object of the present invention to optimize the management of an agricultural area simply and more efficiently.

An assembly according to the present invention may be used for the management of an agricultural area and comprises at least one elongated truss and an associated chassis with at least one wheel with which the truss is movable in a circular or linear manner over the agricultural area, and at least one cultivator that is movable or displaceable along the truss. The assembly shall also include at least one crate, preferably a plurality of such crates, and a conveyor system provided on the truss along its longitudinal extension. At least one crate can be moved with the conveyor system along the longitudinal extension of the truss in a certain direction and thus be brought to a predetermined position, in particular adjacent to the cultivator. This is suitably also possible for a plurality of crates which can be moved along the longitudinal extension of the truss by means of the conveyor system.

For the purposes of the present invention, the feature crate can include any container suitable for holding crops or fruit. Such a crate can be designed as a harvest crate, plant crate, greenhouse crate or the like. Conveniently, handles or the like may be provided on two opposite sides of such a crate, with which such a crate can be grasped. Expediently, such a crate can be made of plastic or wood, or alternatively of (light) metal, e.g., aluminum. In any case, the material of which such a crate is composed or formed according to the present invention is sufficiently stable to ensure both the lifting of such a crate by hand when it is filled with crops and the contact of a number of adjacent crates on a roller conveyor or the like being possible without causing bulging or even cracking in the side walls of the crates.

In addition, it is pointed out here that for the purposes of the present invention the terms crate and container can be understood synonymously. Furthermore, a crate or container can also be rounded or even round in the corner areas.

Via the invention, it is now possible with the conveyor system to bring or move at least one crate to a predetermined position along the truss. For this purpose, the conveyor system may have either a circulating conveyor belt and/or a roller table on which a crate can be placed. In particular, the predetermined position into which the crate can be brought with the conveyor system is adjacent to a cultivator attached to or provided on the truss. If a crate is located along the truss at such a position adjacent to a cultivator, it is possible that either seeds, seedlings or the like may be removed from the crate by the cultivator in order to be used for further management on the agricultural area, or that harvested crops or the like may be returned to the crate during a harvest.

In the same way, the invention also provides for a method for management of an agricultural area in which the above-mentioned inventive assembly can be employed. In any event, it is characteristic of such a method that it is carried out fully automatically and that it involves work steps or crop management process steps from the sowing or seeding of the plants up to their harvesting, wherein during the harvest, a predetermined quantity of harvested crops, possibly also of various plants, is mechanically introduced into a crate provided for this purpose. The method is also characterized in that different crops are planted or harvested on the same agricultural area, wherein when harvesting the crop by means of a cultivator, the crops from different plants are placed together in a common crate.

The conveyor system may comprise a circulating conveyor belt on which at least one crate, for example a plurality of crates, can be placed. It is expedient for such a conveyor belt to be made of a rubberized material or to have such a rubberized material on its surface, so that it prevents a crate from slipping on the conveyor belt.

In addition or as an alternative to a conveyor belt, the conveyor system may be provided to include a roller table with a plurality of carrier rollers, each with a horizontal axis of rotation. In this case, at least one crate can be placed on top of the roller table rollers. Optionally, it is also possible for the roller table to have a plurality of guide rollers, each with a vertical axis of rotation, wherein the guide rollers are arranged laterally on the roller table and thus limit the roller table laterally. With the aid of the above-mentioned rollers, it is possible for the conveyor system in the form of a roller table to move at least one crate along a longitudinal extension of the truss with low rolling resistance.

The present invention focuses on a method for managing agricultural areas and/or an assembly designed for that purpose which has a truss with a considerable longitudinal extension. In view of its longitudinal extension, this truss is preferably of a lightweight construction, for example a structural element made of aluminum. In principle, the truss can be of any length, for example a length of at least 10 meters or more, about 25 meters. Alternatively, a longitudinal extension of >30 meters is also possible for the truss.

Thanks to the above-mentioned design of the truss, which has a considerable longitudinal extension and can be designed as a gantry system, the advantage is that when the truss is moved, a large area of ground or arable land can be scanned and thus managed, thereby significantly reducing soil compaction on the ground or arable land. This way, less energy is needed for soil preparation after harvest and more CO2 can be stored in the soil than with conventional management.

According to the invention, the truss can be equipped with at least one cultivator or application that can be moved or displaced along the truss. Such movability can be achieved, for example, with the aid of a so-called carriage or the like, which is attached to the associated guide rails of the truss.

According to the invention, it is provided that the truss can be used to manage an agricultural area in the open air, i.e., a so-called open space. Against this background, it is reiterated that the inventive assembly with its truss can be displaced or moved over this agricultural area with the aid of an associated chassis, which has at least one wheel.

With the aid of the present invention, a highly automated management system for an agricultural area is advantageously realized, which—thanks to the invention—can be planted with different vegetable crops. In this case, the truss can either be moved in a circular path about a stationary central column to which the truss is articulated or moved along a linear trajectory over the arable or field area. In the latter case, a chassis is provided at each end of the truss with wheels that roll on the arable land.

The present invention also provides for a system for the management of an agricultural area, which comprises an assembly explained above, which fulfills the function of a base station on an agricultural area. Such a system also includes at least one platform that can be moved relative to the agricultural area, with at least one cultivator attached to the chassis of the platform or part thereof, capable of carrying out a crop management process step, and a conveyor system attached to or on the chassis of the platform or a part thereof. In this case, the platform is provided separately from the assembly explained above and is therefore not part of that assembly. At least one crate, preferably a plurality of such crates, can be moved with the conveyor system in the longitudinal or transverse direction of the chassis and thus brought to a predetermined position, in particular adjacent to a cultivator. The at least one platform, or a plurality of such platforms, can be brought to a position adjacent to the truss in such a way that the platform can take over the crates from the truss or crates that are then filled with crops of plants and are on the platform or can be returned to or onto the truss.

The platform can either be part of a mobile field robot or attached or hitched to a tractor or the like.

The platform can be part of a mobile field robot, on a chassis of which a plurality of wheels attached thereto are provided, with which the chassis can be moved over the agricultural area. At least one of the wheels is equipped with a drive. Furthermore, it is preferable to have at least one wheel mounted on the chassis which can be swiveled or rotated about a vertical axis in order to enable the mobile field robot to change its direction of travel.

Also, all wheels of the platform or the field robot can be swiveled about a vertical axis of rotation, so that the mobile field robot can be moved omnidirectionally over the ground of an agricultural area to be managed. In the following, it will be explained separately in what way the feature omnidirectional can be understood within the meaning of the present invention.

The chassis of the platform can be equipped with a coupling device by means of which the chassis can be attached or hitched to a tractor or the like. In this case, it is appropriate for this coupling device to be adapted to a three-point hitch of a tractor and thus be attachable to such a three-point hitch.

The chassis of the platform can be modular and comprises a plurality of elongated and in particular tubular plug-in elements. In particular, these plug-in elements can be connected and detached from each other without the use of special tools, in such a way that at least one of the dimensions of the chassis can be changed. This variable dimension of the chassis is preferably the size or length of the chassis, which runs perpendicular to the direction of travel of the tractor. In addition, it is also possible to change the dimensions of the chassis in the direction of travel of the tractor or parallel to the direction of travel of the tractor, and/or also in the vertical direction.

A control or adjustment apparatus can be provided by means of which a movement of the mobile field robot or the platform over the arable area and/or an actuation of at least one cultivator can be controlled or regulated, preferably that the control or adjustment apparatus can be connected to the chassis or a part thereof or adjacent thereto.

The control or adjustment apparatus can be set up programmatically in such a way that mean cycle times and/or energy requirements can be determined and on the basis of which an agricultural-specific process reliability can be validated. Further advantages are achieved if the control or adjustment apparatus is set up programmatically in such a way that it allows for at least an approximate profitability calculation for the use or operation of the assembly, the mobile field robot and/or at least one cultivator attached to it.

In an example, the system includes a transmitter/receiver unit which is connected by signal to the control or adjustment apparatus, wherein, by means of the transmitter/receiver unit, information or data packets can be received to monitor and/or control the operation of the chassis and/or the cultivator attached thereto or provided, either from a remote location, in particular as a control unit, and/or can be sent to such a remote location. It is also advantageous if the transmitter/receiver unit is attached to or adjacent to the chassis or part thereof.

Further, with regard to the platform, at least one carriage can be attached to associated guide rails of the chassis, which can be moved along a longitudinal extension of the platform. In this case, at least one cultivator is attached to the carriage, wherein the carriage serves as a tool carrier for a cultivator. In the same way as with the assembly according to the invention, the advantage here is that, thanks to a movement of the carriage on or along the guide rails, a cultivator attached or mounted to the carriage can be aligned exactly to a position on the agricultural area or a plant planted in it.

Also, in relation to the platform, at least one cultivator may be attached to a carriage by means of a robotic arm or the like. Such a robotic arm has a plurality of degrees of freedom and/or several arm elements with a plurality of swivel joints with degrees of freedom resulting therefrom, and it may be designed as an industrial robot with at least two degrees of freedom, each with two or more articulated arms, each of which can be swiveled about a vertical or horizontal axis of rotation. Accordingly, it is possible with the aid of such a robotic arm to bring a cultivator attached to it with great precision in the direction of a plant on the agricultural area or to align it in this respect.

The conveyor system may have a support which can be brought into interaction with a crate in order to move the crate in a certain direction along the longitudinal extension of the platform, wherein on associated guide rails of the platform at least one carriage is attached to it that can be moved with it, on which the support is provided.

The platform can have a height adjuster which interacts with the conveyor system in such a way, that the vertical distance between the conveyor system and the agricultural area, and thus its vertical height, can be adjusted to a predetermined value by means of the height adjuster. This has the advantage that if the platform has been moved to a position adjacent to the truss of the assembly and consequently a possible height difference between the conveyor system of the platform and the conveyor system of the assembly or the truss exist, these differences in height can be compensated by activating the height adjuster of the platform by bringing the conveyor system of the platform to the same vertical height as that of the conveyor system of the assembly. In this respect, the predetermined value to which a vertical distance between the conveyor system of the platform and the agricultural area is set by means of the height adjuster can correspond to the vertical distance or vertical height between the truss of the assembly at one end of the platform and the agricultural area. In this way, an operationally safe transfer of crates from the truss of the assembly to the platform, and vice versa, is ensured.

The conveyor system of the assembly and/or the conveyor system of the platform may comprise a support which can be brought into interaction with a crate in order to move the crate in a certain direction along the longitudinal extension of the truss or platform. Such a support may be provided or attached to at least one carriage, wherein this carriage is attached to associated guide rails of the truss or platform and is thus attached to it in a movable manner along a longitudinal extension of the truss or platform. This means that when a carriage is moved, by means of the support provided thereon, a crate located on the conveyor system can be moved along the truss or platform in a certain direction.

By means of a cultivator, which is provided on the truss of the assembly or on the platform of the system according to the present invention, any crop management process steps, according to the invention, can be carried out on an agricultural area, such as sowing and/or harvesting of plants, weeding, targeted watering and/or fertilizing of plants, pruning of plants, and/or a targeted management or loosening of the arable ground. In this case, it may be helpful to use crates, which are transported along the truss of the assembly with the aid of the conveyor system or can be moved along the platform, for example, to transport or bring in seeds or harvested plants.

Advantageous further developments of the invention are formed by the following features, which, where applicable, shall apply in the same way to both an assembly and its truss as well as to a platform of the system of the invention.

The truss may be connected at one end to a stationary central column, preferably articulated via a tilt & turn joint or a corresponding articulated fork, wherein the other end of the truss has a chassis which rolls on the ground or arable land. This means that the truss can be moved in a circle around a centric or centered pivot point, which is formed by the stationary central column. As explained herein, it is also possible that the truss may be equipped with a chassis at both ends, so that the truss can be moved linearly or translationally over the ground.

On the truss or on the platform, several carriages with cultivators attached to it can be provided, which can be moved along a longitudinal extension of the truss or platform. Such a plurality of carriages can be movably mounted on the same side of the truss and/or on different sides of it, i.e., on opposite sides of the truss (i.e., on the left side and on the right side). In particular, in the event that several such carriages are provided with the cultivator attached to them on opposite sides of the truss, it is possible that the carriages or cultivators are moved on one side of the truss, independently of the carriages or cultivators which are provided in each case on the other or opposite side of the truss.

A cultivator can be connected to the truss or platform or to a carriage by means of a robotic arm. Preferably, such a robotic arm can have a plurality of degrees of freedom, and/or several arm elements with a plurality of swivel joints with resulting degrees of freedom. This advantageously results in flexible movability with a large radius for a cultivator that can be attached to the free end of the robotic arm. This makes it possible to manage or reach crops on the agricultural area that are not immediately adjacent to or below the truss or the platform.

The above-mentioned robotic arm can be designed as a SCARA robot. Such a SCARA robot is known to have four axes and four degrees of freedom, which advantageously results in a large operating radius for the cultivator, which can be mounted at the lower end of the z-axis. And/or:

Various types of cultivators can be mounted on a carriage. For example, it is possible for different types of such cultivators to be mounted on a carriage at the same time. In addition to or as an alternative, it is possible according to the invention to replace one cultivator with another on at least one carriage as needed. For this purpose, the invention provides a tool change system on the truss or on the platform, with which a number of different types of cultivators are provided on the truss or on the platform and, if needed, a cultivator can be replaced by another on at least one carriage. Such an exchange takes place, for example, in the event that another crop is to be managed and/or another management process is to be carried out.

The above-mentioned tool change system can form a kind of storage container for various types of cultivators. In order to equip at least one carriage with a cultivator of a predetermined type, it is appropriate that the tool change system also be designed to be movable along the longitudinal extension of the truss, so that—if necessary—a cultivator can be replaced more quickly and with greater flexibility on a selected carriage and a robotic arm attached to it, on which the planned exchange cultivator can also be mounted.

The cultivator, which can be mounted on a carriage (or alternatively: directly on the truss), can be, for example, an irrigation applicator, a fertilizer applicator, a manipulator or applicator with at least one vertical axis of rotation or axis of manipulation and with other peripheral assembly attached to it and/or an industrial robot (e.g. manipulator) with at least two degrees of freedom (DOF, also SCARA or delta robot). If such an applicator or manipulator is equipped with two or more vertical axes of rotation, this means, for example, that it has two or more articulated arms, each of which can be swiveled about a vertical axis of rotation. Alternatively, it is also possible for such articulated arms to be swiveled about a horizontal axis.

On the truss of the assembly, in the function of the main truss, at least one secondary truss can be mounted in a movable or telescopic way, or be hingedly mounted in any arrangement (horizontally, vertically, diagonally) above a spherical plain bearing. In the same way as on the main truss, at least one carriage with cultivator attached to it which can be moved in the longitudinal direction of the secondary truss may also be provided on such a secondary truss. Alternatively, at least one cultivator may be attached directly to such a secondary truss. Thus, a working radius for the management system according to the present invention can be advantageously extended without further compaction of the managed arable land.

By means of the truss or the platform and tools or cultivator attached to it, which can be movably guided along the longitudinal extension of the truss or the platform, ground loosening can also only be achieved, according to the invention, locally in the area of the plants that are introduced into the arable or an agricultural area. A movement of a cultivator relative to the agricultural area is achieved in respect of a platform in that that platform itself is moved on the arable area, either as part of a mobile field robot or by means of a hitch or attachment to a tractor.

By means of the different types of cultivator, which, as explained, can be mounted on a carriage (or alternatively: directly on the crossbar), all processes of management of an agricultural area are covered or possible, such as ground management (e.g., ploughing, grubbing), sowing of plants, crop protection, irrigation, fertilization, harvesting and, if necessary, logistics for a pick-and-place approach.

Each carriage can be equipped with a tool change system, with which, as explained above, it is possible to mount various types of cultivators on a carriage associated to it.

In the case of a carriage, which as explained, is movably mounted along the longitudinal extension of the truss, it can be understood that such a carriage, together with the cultivator attached to it, can then be moved or displaced along the truss during the movement of the truss, which can be either circular around a center or linearly or translationally along the arable land. This allows for plants to be reached at any location, in other words, any location of the arable land by the cultivator in order to carry out a desired management or harvesting operation.

A conveyor system of the assembly or platform can be designed to be activatable or effective in both directions of the longitudinal extension of the truss of the assembly or the chassis of the platform. At least one crate can be moved along the truss in both directions. The same is of course also true for a plurality of crates placed on a conveyor belt or roller table of the conveyor system.

With regard to a conveyor system which is provided for the assembly or a platform of the system in accordance with the invention, several such conveyor systems may also be provided on the truss of the assembly or the chassis of the platform. In this case, these several conveyor systems can be arranged vertically on top of each other and/or horizontally next to each other. For this purpose, appropriate mechanical precautions have been taken on the truss of the assembly or the chassis of the platform to enable such an arrangement of a plurality of conveyor systems.

At a cultivator and/or an associated carriage, as explained above, at least one sensor or an equivalent sensor package may be provided movably along the truss or platform. This allows for workspace monitoring and a suitable identification of plants that are processed or harvested by the cultivator.

The truss and/or platform, as part of a mobile field robot, is equipped or fitted with a plurality of solar panels and has at least one battery storage that is electrically connected to the solar panels. It is thus possible to supply or charge this battery storage during the day with the electricity generated by the solar panels and thus cover the energy needs of the truss or the mobile field robot and the associated equipment. This means that the battery storage can also serve as a night storage unit at night in order to ensure continuous operation of the truss or the mobile field robot according to the invention and the attachments attached to it. In this way, a self-sufficient power supply to the truss or the field robot according to the invention and the equipment provided on it is ensured. For example, it is possible that a total of 75 solar panels are mounted in two rows over the total length of the truss. This makes it possible to cover 100% of the energy demand, thus ensuring the self-sufficient power supply of the inventive truss with the attached equipment.

The above-mentioned solar panels are preferably mounted above the truss or in an upper area thereof. Accordingly, these solar panels function as weather protection for the truss. The same applies to a mobile field robot, where such solar panels can be mounted above the chassis of the platform.

Along the truss or the platform, at least one crate is movable. Such a crate can be used to move seed from the center to a desired location of the truss in order to carry out the sowing of a plant in the field. In addition to or alternatively, the crate can be used—in accordance with its name—to pick up crops taken out of the ground of the agricultural area by a tool during harvesting and then transport them back to the center along the truss. The above-mentioned crate be a conventional standard vegetable crate.

With regard to the use of at least one crate, the conveyor system, which can be integrated into an upper area of the truss or platform, ensures that such a crate or even a plurality of crates are moved along the longitudinal extension of the truss or platform in a targeted manner, preferably in both directions. If the invention is designed as a circular management system, it is possible to transport the crates radially from the center, i.e., from the center stationary column over the truss, to the outside using such a conveyor system. The same applies to the opposite direction, i.e., for transporting the crates radially inwards, i.e., in the direction of the center stationary column.

The truss and/or the conveyor system of the assembly and/or the platform can be equipped with a storage or roll magazine in which a plurality of crates can be stored. Such a magazine can hold a number of >>10 crates, for example 10, 20, 30, 40 or 50 such crates, or an even larger number of crates.

By means of the invention, it is possible to grow more than 25,000 vegetable plants economically on an agricultural area with a size of ¼ hectare—this is 25% more than in conventional management. If designing the invention as a circular management system, in which the truss is moved in a circle around a stationary central column, 600 seedlings can be used per day and a comparable number of plants can be harvested. At the same time, selective harvesting enables a further increase in the efficiency of, for example, 10% as compared to conventional management.

An apparatus with at least one nozzle can be attached to the truss and/or platform by means of which a liquid can be injected into a specific point on the ground of the agricultural area. In this case, it is advantageous if this apparatus can be moved along the longitudinal extension of the truss. After the nozzle apparatus has reached a predetermined point on the truss, a targeted insertion of the at least one nozzle into the ground of the agricultural area can be achieved, e.g., by means of a height adjustment apparatus. The liquid can be water to irrigate the plants planted in the ground in a targeted manner, and/or an aqueous solution with fertilizer to fertilize the plants in a targeted manner.

If the nozzle apparatus injects water into the ground, for example adjacent to or in the immediate vicinity of the plants to be irrigated, according to the invention this may correspond to a minimum amount of irrigation, with which a water savings of about 80% is achieved as compared to conventional management.

By means of the invention, with the use of suitable tools or cultivator, which, as explained, can be mounted on a carriage, ecological crop protection without chemicals and a point-shaped ground preparation or incorporation of crop residues with maximum ground protection and energy efficiency is achieved.

According to the invention, it may be provided for the management of an agricultural area to be carried out fully automatically, for example from the sowing of the plants to their harvest. A characteristic of such a management approach can include sowing or harvesting different crops on the same agricultural area. In the course of this, it is then possible to collect different plants together in a common crate when bringing in the harvest, for example for the purpose of direct marketing to potential consumers. As a result, with the aid of the invention, it is possible to save at least one trade or processing stage in the course of the utilization of the harvest brought in and thus to achieve attractive market prices.

With the aid of the present invention, so-called spot farming can be realized on an agricultural area, where the management of an agricultural area is concentrated only on targeted planting points where plants are introduced into the ground. At these planting points, the plants are sown, watered and, if necessary, fertilized, and finally, the mature plants are harvested. Such a type of management can replace monocultures and at the same time promote biodiversity or species diversity.

Crop management and harvesting processes can be mapped as pick-and-place processes. This makes it possible to carry out these processes across crops, i.e., for different species and sizes of vegetable plants. For example, it is possible to mount a suitable cultivator on a carriage in the form of a gripping tool that can be used to harvest heads of lettuce and cabbage, even kohlrabi, of any size.

As explained above, the present invention makes it possible to manage an agricultural area with different varieties of plants or vegetables. Proposed crops can be the following: iceberg, head and romaine lettuce, red and white cabbage (mini), broccoli, kohlrabi, celery, cucumber and zucchini, as well as pumpkin. In other words, the present invention makes it possible and provides for the mixed management of plants or vegetables to be carried out on an agricultural area.

According to the invention, harvesting process steps for the plants are preferably automated and may be at night. This may be provided, in particular, in the case where, as explained above, the agricultural area is planted with different varieties of plants and vegetables. In the course of harvesting, it is possible to harvest these different varieties or plants directly from the field into the crates, which can be transported along the truss or platform as explained above. There is the possibility of a stationary addition of potato, onion and carrot crates, thus completing the offer for the end customer.

By means of the present invention it is possible to manage a large number of different vegetable crops either with integrated cultivator or planting tools or a plurality of such equipment or tools, which can also be mounted on a carriage at the same time, in the sense of individual micro-spot farming. In part, advantageously, this can be done either at least partially automated or preferably also fully automated, preferably according to the specification of corresponding target data with regard to individual process steps and their chronological sequence with regard to the management of an agricultural area.

The truss may be equipped with a control or adjustment apparatus by means of which the movement of the truss, either in a circular manner around a center or in a linear or longitudinal manner along the agricultural area being managed, and/or the movements or operations of the cultivators attached to it can be suitably controlled.

Expediently, the above-mentioned control or adjustment system may be set up programmatically in such a way that the various controls of the truss and/or the cultivator attached to it and/or with regard to the transport of a crate along the truss can be executed in the manner of a control loop, i.e., in a controlled manner. The same applies to the platform according to the inventive system.

It is also possible by means of the control or adjustment apparatus to validate calculated average cycle times, estimated energy demand and/or agricultural-specific process reliability.

The control or adjustment apparatus should be set up programmatically in such a way that it is also possible to calculate at least approximate profitability for the use or operation of the truss or platform according to the invention. The same applies to a corresponding further development of an inventive method.

The truss or the platform, as part of a mobile field robot, can be equipped with a transmitter/receiver unit that is connected to the control or adjustment apparatus in terms of signals. By means of this transmitter/receiver unit, it is possible to either receive information or data packets from a remote location (e.g., in the form of a control station for monitoring and/or controlling the operation of the truss of the invention) and/or transmit to such a remote location. Expediently, when the invention is designed as a circular management system such a transmitter/receiver unit can be connected to the stationary central column, and preferably to an upper part of it, so as to achieve a good transmitter or receiver power for the data to be transmitted from and/or to the remote location.

It is also possible to directly process the plants to be cultivated with the cultivator attached to a carriage or to the truss or platform. Such processing may include the plant being cut up by means of a cultivator or a suitably designed tool and/or that non-edible biomass is separated from the plant. The term non-edible biomass may be understood in that it is the dying biomass of the plants to be managed, which can be caused by rotting, insect infestation, or nutrient and/or water deficiencies.

In order to improve the quality of the crop, the present invention provides that non-edible biomass is separated from the plants to be harvested. Such separation of non-edible biomass can be carried out at a stage of the plant (e.g., broccoli) while it is still attached to the agricultural area. In addition or alternatively, this can also be done in the course of a process step, when the plant is taken from the ground during harvesting. In any event, such a cutting of plants and/or the separation of non-edible biomass is supported by a preferably optical sensor, which may be fitted to a cultivator or an associated carriage, as explained above, and which can then be used to detect the plant and its position and/or size.

The separation of non-edible biomass, as explained above, is also to be seen according to the invention in the context of protecting the remaining healthy plants or parts of plants and thus achieving active plant protection. In the same way, it promotes growth through influencing the foliage and promoting new shoots on the remaining healthy plants or parts of the plant.

On the control or adjustment apparatus, algorithms for new processes or process steps can be implemented on the software side. Thus, by means of the invention, reliable and, in particular, weather-independent training data for neuronal networks can be generated. The time-consuming masking of plants is reduced if the same plants are recorded in the same position every day using the sensors or cameras provided for this purpose. Another advantage is that monitoring is also quite possible after the end of the row in the advanced growth stage of the plants to be managed. This aspect applies in the same way to the operation of the truss in accordance with the invention and also to an appropriately developed method according to the present invention.

The truss (i.e., the main truss and/or a secondary truss) may be equipped with one or more drag chains which, in addition to a receptacle for electrical lines, the routing of an irrigation pipe and/or a pipe for fertilizers (e.g., organic fertilizer) is also realized.

It is also possible to use the cultivator to rid the growing area of an agricultural area of weeds. In this case, it can be provided that such weeds are taken out of the ground by means of suitable gripper arms and then introduced into crates adjacent to them on the truss or platform. Following this, the removed weeds can then be transported away by means of the crates via the truss or platform, so that they no longer proliferate on the agricultural area or lie around loosely.

Due to the high degree of automation in the management of an agricultural area according to the present invention and the associated precision through visual servoing, there is also the significant advantage that chemically synthesized pesticides can be completely substituted. This also has the advantage that large quantities of water can be saved through selective precision irrigation. As compared to conventional vegetable management, the water saving amount to about 80%.

For the wheels of a chassis which is mounted on at least one end of the truss, it may be provided in the sense of a management system that a lane on the surface of the agricultural area is at least slightly compacted or provided with a comparable fastening. As a result, the wheels roll when the truss moves on this (circular or linear) lane, so that the use of the truss according to the invention is not impaired or interrupted even in the event of rain. Accordingly, the present invention also advantageously achieves weather independence for the management of an agricultural area.

By means of the movable carriages attached to the truss, it is possible to roll out or spread preferably triangular foils in the radial direction, from the outside to the inside, on the agricultural area, comparable to a roller blind. This makes it possible to improve the climatic conditions on the agricultural area for the crops on it if necessary.

The truss can be equipped with a telescopic mechanism, which allows for the length of the truss to be changed in the direction of its longitudinal extension. This makes it possible to adapt the length of the apparatus individually to the conditions of the agricultural area to be managed. This also applies to the operation or use of the apparatus according to the invention.

In the event that the truss is connected to an end at a stationary central column and is thus designed as part of a circular management system, further advantages of the invention result from the below aspects.

In connection with the above-mentioned telescopic mechanism, a change in the length of the truss that can be realized with it can also be achieved in the course of or during the rotational movement of the truss about the stationary central column, so that as a result, arable land that is rectangular or has any number of corners (e.g., trapezoids and polygons) can be scanned and managed according to the invention by means of the truss.

At the stationary central column, at least one sensor may be provided to detect the movement of the truss and a carriage attached to it (or a plurality of such carriages) with the associated cultivator. Preferably, such a sensor is designed as a sensor package and includes a plurality of individual sensors, with which, for example, all-round monitoring is possible, i.e., in an angular range of 360° around the stationary central column. In addition to or as an alternative, it may be provided that the sensor is mounted on the stationary central column so as to swivel and can thus be oriented in the direction of the truss in order to detect the position of the truss and, in particular, the carriages attached to it among associated cultivator.

In the area of the stationary central column or adjacent to it, a base terminal can be provided with which the necessary field logistics can be realized. This means that, by means of this base terminal, it is possible, for example, to provide or distribute seeds and/or to pick up or receive harvested crops, preferably through the use of the crates mentioned above. By using such crates, which can be transported along the truss in both directions, it is possible, on the one hand, to transport seed from the base terminal to the respective carriages with the cultivator attached to them and/or on the other hand, to bring crops taken from an agricultural area or arable land back to the base terminal. Thus, by means of the present invention, a high degree of integration for a system for the management of an agricultural area is realized, combining for the first time the advantages of conventional large and small field robots.

The centric support from one end of the truss at the stationary central column has at least two degrees of freedom, so that the truss can also be installed in a terrain with a slope.

In view of the considerable longitudinal extension of the truss explained above, the present invention can be understood as a bridging technology, because the considerable longitudinal extension of the truss and the use of applicators or tools attached to it for management in conjunction with a characteristic movement of the truss over the agricultural area to be managed leads to the above-mentioned advantages of the invention as compared to the state of the art.

For the purposes of the present invention, the terms or features cultivator, field management device, and/or field cultivation device may be understood interchangeably.

When carrying out the method according to the invention and/or when using the apparatus or system of the present invention, it may be provided that the crop management process steps are carried out either when the apparatus is at a standstill or the platform, or that these crop management process steps are carried out during a horizontal movement of the apparatus or platform relative to the agricultural area and that this horizontal movement has a speed of 10 m/s or less. In the latter case, it is advantageous if this speed is significantly less than 10 m/s, e.g., only 5 m/s, preferably up to 1.5 m/s, which corresponds to a human walking speed. The said standstill of the apparatus or platform, or its horizontal movement relative to the agricultural area at a very moderate speed, as explained above, is advantageous with respect to an implementation of crop management process steps in that the apparatus or platform is located in a specific zone of an agricultural area to be managed. This has the advantage that, in the said specific zone of the useful area, selected crop management process steps are carried out by the apparatus or platform, on which at least one cultivator is attached, with surgical precision selectively in respect of a single plant, individual plant components or a single planting position. Only after at least one selected process step or several such process steps have been carried out or completed in the predetermined zone of the arable area, the apparatus or platform is then moved, either on its own wheels or, in the case of the platform, in the form of a second variant described below by a tractor or the like provided for that purpose, into a preferably adjacent next zone of an agricultural area to be managed, in which selected crop management process steps are then carried out again by the apparatus for at least one plant.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of an inventive apparatus with a truss moving in a circle around a center, and enlarged views of parts thereof,

FIG. 2 is another perspective view of the apparatus in FIG. 1,

FIG. 3 is a top view of the apparatus in FIG. 1,

FIG. 4 is a side view of the apparatus of FIG. 1 or FIG. 2,

FIG. 5 is another perspective view of the apparatus of FIG. 1,

FIG. 6 is a perspective view of a cultivator which is part of the apparatus of FIG. 1,

FIG. 7 is a perspective view of the cultivator in FIG. 6, if it is attached to the truss of the apparatus of FIG. 1,

FIG. 8 is a side view of the cultivator of FIG. 7,

FIG. 9 is a perspective view of a section of the truss of FIG. 1 and of an associated conveyor system with a crate held in it,

FIG. 10 is a perspective view of a section of the truss of FIG. 1 with a plurality of crates held in it,

FIG. 11 is another perspective view of the cultivator from FIG. 7,

FIGS. 12, 13 are schematically highly simplified side views of the truss with a conveyor system attached to it with a roller table that can be adjusted in its inclination relative to the horizontal,

FIG. 14 is an upper part of a stationary central column, which is part of the apparatus of FIG. 1 and to which the truss is articulated,

FIGS. 15, 16 are side views of the central column of FIG. 14,

FIG. 17 shows a chassis mounted at one end of the truss,

FIGS. 18, 19 are a perspective view of an apparatus according to an example of the invention, in which a truss is linearly movable along or on arable land,

FIG. 20 is a perspective view of a platform as part of a mobile field robot, which is part of an inventive system for the management of an agricultural area,

FIG. 21 is an enlarged view of a part of the field robot in FIG. 20,

FIG. 22 is a perspective view of a platform attachable to a tractor, which is part of an inventive system for the management of an agricultural area,

FIG. 23 is a side view of the platform of FIG. 23, and

FIG. 24 is a perspective view of the field robot from FIG. 20 and part of the apparatus of FIGS. 1-19, as part of the inventive system for the management of an agricultural area.

### DETAILED DESCRIPTION

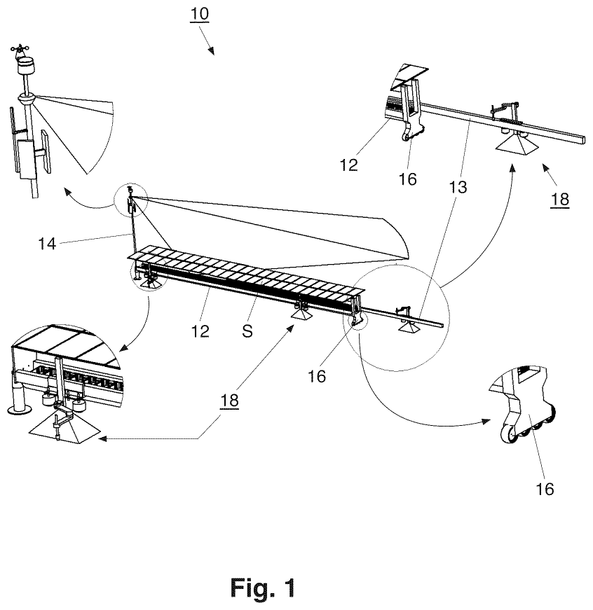

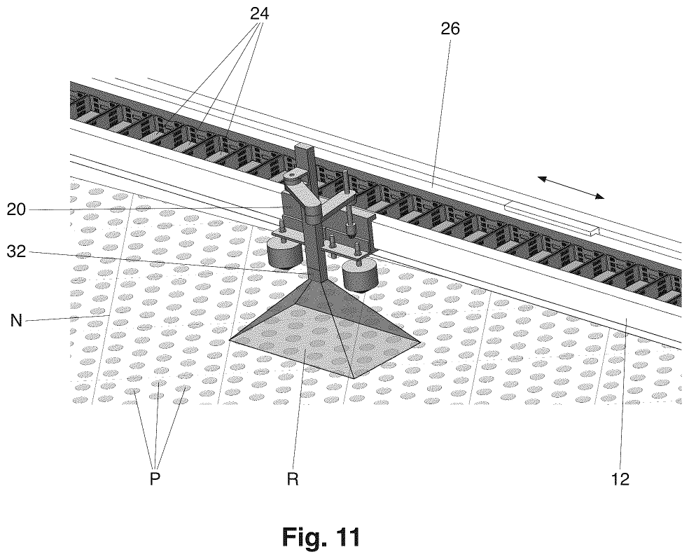

Below, with reference to FIGS. 1 to 24, examples for an assembly 10, 10′ according to the invention of a corresponding method and also a system are explained in order to manage an agricultural area N (cf. FIG. 11, FIG. 19).

FIG. 1 shows a perspective view of the inventive assembly 10 according to an example in which a truss 12 is hinged with one end to a stationary central column 14. At the other end of the truss 12, i.e., opposite to the central column 14 is a chassis 16 with wheels which roll off on a floor surface.

Some areas of the assembly 10 according to the invention are circled in FIG. 1 and shown in an enlarged form adjacent to this. Details of these enlarged areas are explained in further figures below.

The truss 12 is articulated with the stationary central column 14 in such a way that the truss 12 is moved around the central column 14 along a circular path.

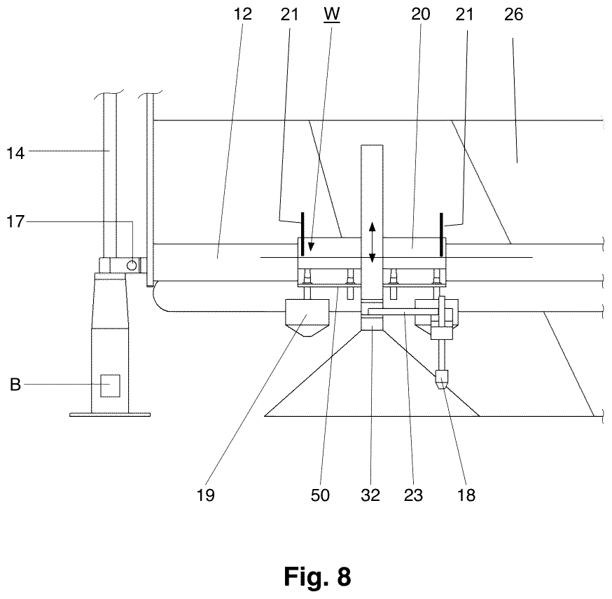

The linkage of the truss 12 to the stationary central column 14 may have a rotary tilt joint 17 (FIG. 8) with a horizontal axis of rotation: In this case it is possible that the end of the truss 12 opposite to the central column 14, to which the chassis 16 is attached, can be swiveled relative to the central column 14. This makes it possible to compensate for uneven ground or the use of the inventive assembly 10 on or in undulating terrain. In other words, in the operation of the inventive assembly 10 it is possible to drive on inclined planes or to use the truss 12 of the assembly 10 on such terrain thanks to the rotary-tilt joint 17.

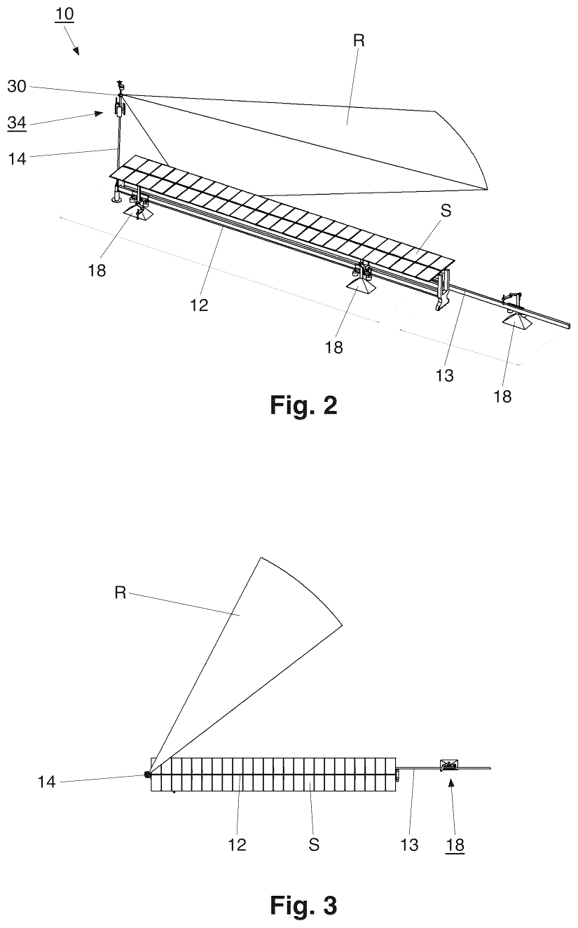

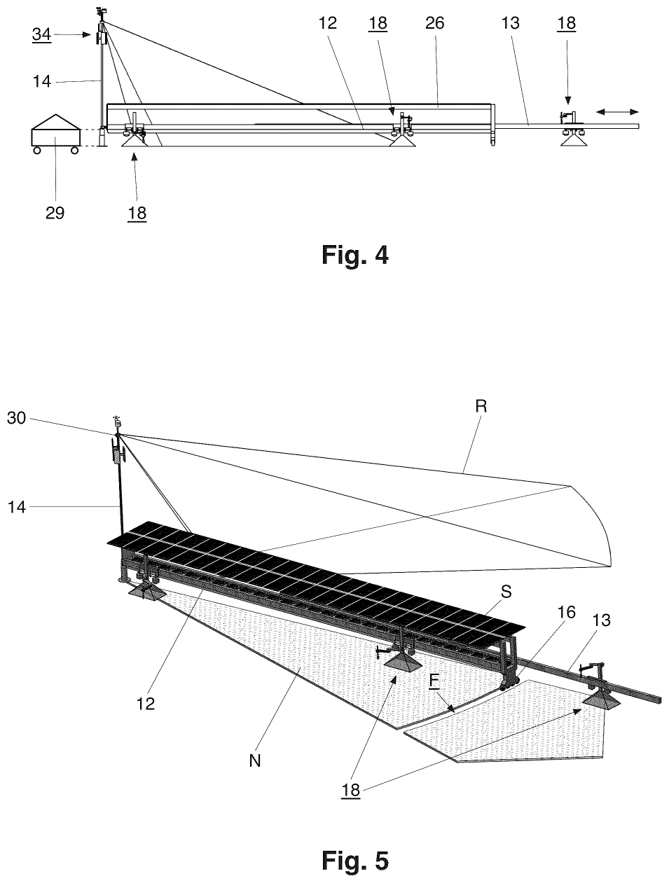

FIG. 2 shows the assembly 10 of FIG. 1 in another perspective view. From here it can be seen that a secondary truss 13 is attached to the free end of the truss 12, in its function as the main truss. This secondary truss 13 can be adjusted telescopically relative to the main truss 12. This means, that on the main truss 12 a guide apparatus is provided, preferably with motorized means, whereby the length of the secondary truss 13 can be adjusted relative to the main truss 12. Such a telescopic adjustment of the side beam 13 is also shown in FIG. 4 (on the right edge of the picture), symbolized by a corresponding double arrow.

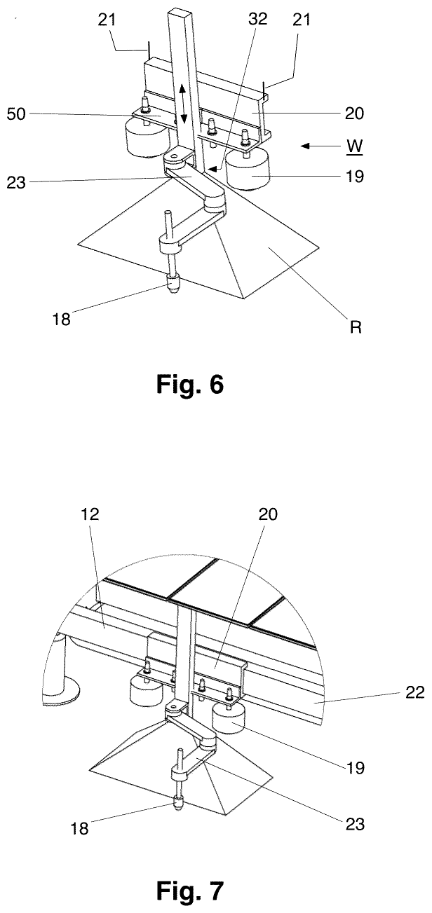

At least one cultivator 18 is attached to truss 12, which can be moved along the truss 12. For this purpose, a carriage 20 (FIG. 6) is provided, which is attached to the truss 12 by means of guide rails 22 (FIG. 7) and is hereby longitudinally displaced along the truss 12.

An adjustment or displacement of a carriage 12 along the truss 12 can be carried out with suitable motorized means.

A number of cultivators 18 are attached to the truss 12. This is can be understood as meaning that cultivators 18 are installed on both sides of the truss 12 (see FIG. 16) and/or that several cultivators 18 are each mounted on the same side of the truss 12, as illustrated, for example, by FIG. 2. In this connection, it is pointed out separately that a carriage 20 may be associated to each individual cultivator 18, by means of which a longitudinal displacement of the cultivator 18 along the truss 12 is realized.

A cultivator 18 can be attached to the truss 12 or to an associated carriage 20 by means of a preferably articulated robotic arm 23. This is illustrated by FIG. 6 and FIG. 7. Such a robotic arm 23 has several degrees of freedom and, preferably, several arm elements articulated to each other by means of which a flexible movement of the cultivator 18, which is attached to a free end of the robotic arm 23, is possible in the space. This also includes a vertical adjustability of the robotic arm 23, so that the working height of the cultivator 18 or its distance to the ground can be changed as required.

This vertical adjustability is symbolized, for example, in FIG. 6 by a corresponding double arrow.

The assembly 10 includes a tool change system, which makes it possible to mount different cultivators on a robotic arm 23, depending on the purpose or type of management of an agricultural area N.

FIG. 6 shows a simple form for the tool change system W mentioned above, which here is formed of a retaining plate 50 attached to a carriage 20, on which at least one other cultivator 19 can be stored. If, for example, it is desirable to replace the cultivator 18, which is already mounted on the free end of the robotic arm 23, with the cultivator 19, the cultivator 18 on the retaining plate 50 can be set down at a free position of it, so that the other cultivator 19 is then mounted on the free end of the robotic arm 23. This other cultivator 19 is then used to carry out another crop management process step.

If one or more cultivators are placed or arranged on the retaining plate 50, the retaining plate 50 fulfills the function of a parking area.

Furthermore, it is pointed out that a cultivator 18 may also be attached to the secondary truss 13. This can be done with or without the use of a carriage 20 or a robotic arm 23.

The above-mentioned replacement of a cultivator 18, 19 at a free end of the robotic arm 23 is preferably fully automatic. In any event, such an exchange of one cultivator for another normally serves to prepare for a change of a crop management process step, which is used to manage plants P grown on the arable area N.

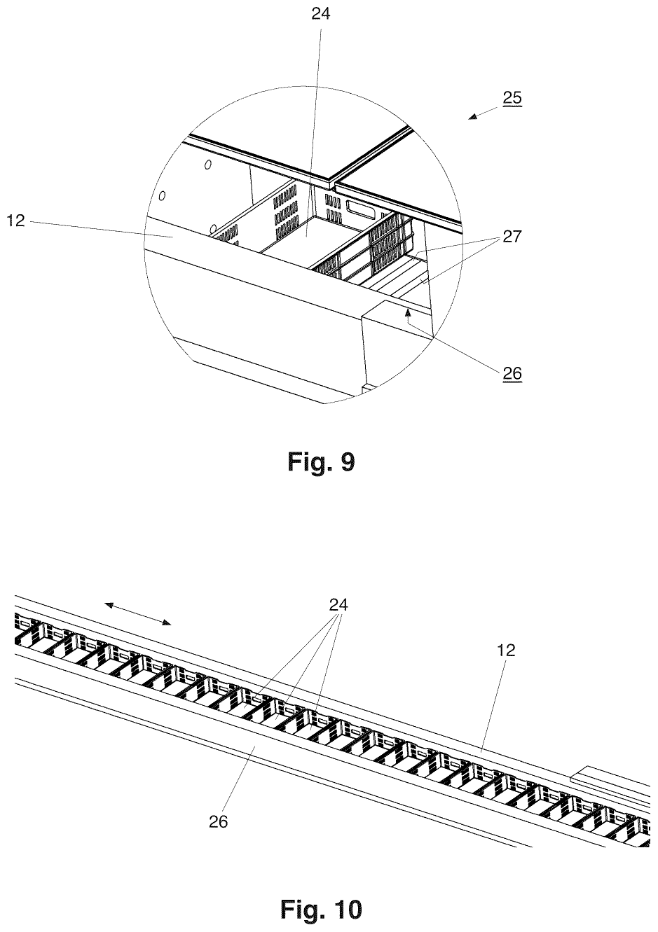

The assembly 10 comprises a crate 24 (see FIG. 9), preferably a plurality of such crates 24, and a conveyor system 25 which is provided along the longitudinal extension of the truss 12 (cf. FIG. 10, FIG. 11). With the aid of this conveyor system 25, at least one crate 24 can be moved along the truss 12. It is expedient for the conveyor system 25 to accommodate a plurality of such crates 24, as indicated by the perspective view of the truss 12 according to FIG. 10.

The conveyor system 25 is conveniently provided on an upper side of the truss 12 or integrated in an upper area of the truss 12.

The conveyor system 25 can be designed as a conveyor belt system. In this case, a circulating conveyor belt is provided on which the crates 24 can be placed. When this conveyor belt circulates, the crates 24 are then moved or transported to a predetermined position, preferably adjacent to a cultivator 18 attached to the truss 12.

In addition to or as an alternative, the conveyor system 25 may be equipped with a roller table 26 which has a plurality of carrier rollers 27, each with a horizontal axis of rotation. The conveyor system 25 shown in FIG. 9 comprises such a roller table 26, in which two carrier rollers 27 can be seen.

Optionally, it is possible for the roller table 26 to also have a plurality of guide rollers, each with a vertical axis of rotation. These guide rollers are arranged on the sides of the roller table 26 and thus limit the roller table 26 to the side.

In any case, a crate 24 can be placed on top of the carrier rollers 27 of the roller table 26, wherein a movement of the crate 24 is possible with only very low rolling resistance due to the contact with the individual rollers of the roller table 26 along a longitudinal extension of the truss 12.

The perspective views of FIGS. 10 and 11 illustrate that the roller table 26 of the conveyor system 25 is provided along the longitudinal extension of the truss 12. In this respect, it may be provided that at least some of these rollers of the roller table 26, preferably one or more of the carrier rollers 27, are motor-driven in order to achieve a targeted transport of the crates 24 in a desired direction along the truss 12 on the roller table 26.

With regard to the above-mentioned roller table 26 of the conveyor system 25, it may be pointed out separately at this point that this roller table 26 fulfills the function of a storage or roller magazine within the meaning of the present invention. In any event, this roller table 26, in the sense of its function as a storage or roller magazine, fulfills the purpose of accommodating a large number of crates 24 with or in it, namely along the longitudinal extension of the truss 12.

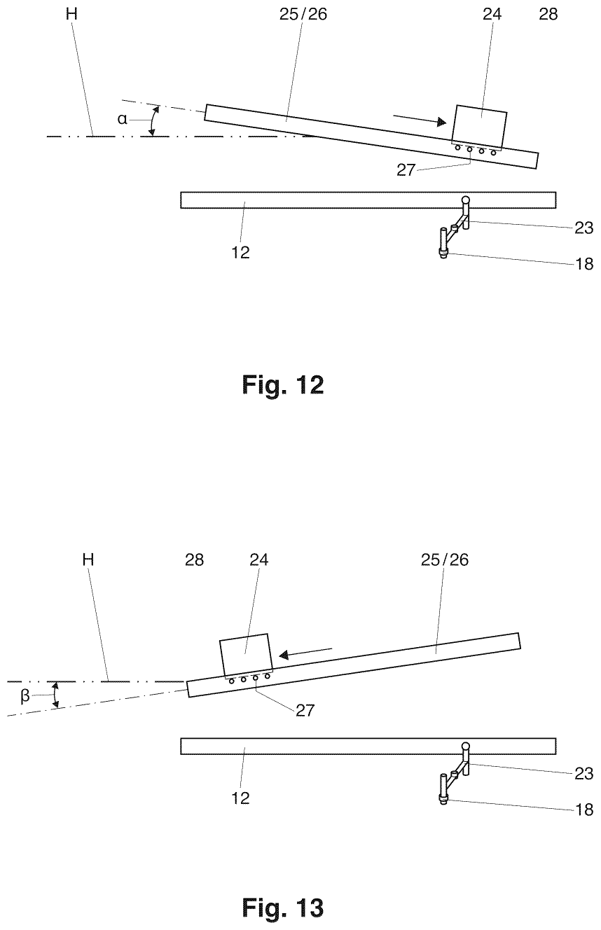

FIG. 12 and FIG. 13 illustrate below that the roller table 26 of the conveyor system 25 can be adjusted in its positioning or inclination to the horizontal H. In detail:

The roller table 26 of the conveyor system 25 is mounted in a swivel bracket, the position of which changes relative to the horizontal H or can be adjusted. To adjust the inclination of the roller table 26, the assembly 10 includes separate means with which the support for the roller table 26 can be controlled accordingly in order to realize a changed position for a desired inclination of the roller table 26. This makes it possible to set a position for the roller table 26 in which it encloses an angle with its longitudinal extension relative to the horizontal H and thus runs obliquely. As a result, a crate 24, if it is placed on this inclined roller table 26, will automatically move by force of gravity and without a separate drive towards the lower end of the roller table 26. In the same way, this also applies to a plurality of crates 24.

The illustrations of FIG. 12 and FIG. 13 may respectively refer to FIG. 1, wherein the stationary central column 14 is located at the left end of the truss 12.

FIG. 12 also illustrates that a cultivator 18 is attached to the truss 12 by means of a robotic arm 23.

With regard to the illustration of FIG. 12, it is pointed out separately that here the roller table 26 is adjusted in such a way that its longitudinal axis encloses an angle alpha with the horizontal H and thus, the end of the roller table 26 shown in the image area to the right is lowered. This way, a crate 24, which is placed on the roller table 26, automatically moves from left to right, as it is also symbolized by an arrow in FIG. 12, due to the gravity on the carrier rollers 27. This allows for a crate 24 to be moved from the stationary central column 14 to the opposite end of the roller table 26.

The roller table 26 is equipped with an actuatable stop element 28, conveniently located in a place adjacent to the position of the cultivator 18. The function of this stop element 28 is based on the fact that if a crate 24 moves on the roller table 26 due to gravity towards the lower end (from left to right in FIG. 12), this stop element 28 is actuated or activated at exactly the time when the crate 24 has reached the position of the cultivator 18. As a result, the crate 24 is then blocked on the roller table 26 and thus stopped at the position of the cultivator 18. In this way, even in the case of a passive roller table 26 whose roller elements do not have a separate drive, it is possible to move a crate 24 to a predetermined position which may correspond, for example, to the position of a cultivator 18, as explained above.

With regard to the above-mentioned stop element 28, the roller table 26 may be equipped with a large number of such stop elements 28 along its longitudinal extension. These individual stop elements 28 can be located at positions adjacent to cultivators 18. This ensures that individual crates 24 on the roller table 26 can be stopped by actuating the stop element 28 adjacent to a selected cultivator 18 if, as explained, the roller table 26 is tilted by an angle with its longitudinal axis relative to the horizontal H.

FIG. 13 illustrates another possible position with respect to the roller table 26, in which its longitudinal axis encloses an angle beta with the horizontal H and thus the roller table 26 is tilted obliquely downwards in the direction of the stationary central column 14. This ensures that a crate 24 placed on the roller table 26 automatically moves from right to left as a result of gravity. Such a movement may occur, for example, when a harvesting process, in which crops have been harvested from the arable area N into the crate 24 by means of a cultivator 18 attached to a robotic arm, is completed and then the crate 24 is to be transported back in the direction of the stationary central column 14. In the same way as already explained in FIG. 12, for the inclination of the roller table 26 in the opposite direction, as shown in FIG. 13, it is possible to stop a crate 24 located on the roller table 26 in a targeted manner by activating a stop element 28. For example, such a stop element 28 can be located adjacent to a storage or roller magazine into which the crate 24 is transferred for further logistics of the harvested crops brought into it.

At this point, it is indicated separately that a swivel design of the roller table 26 in which, as explained, its longitudinal axis can enclose an angle with the horizontal and thus the roller table 26 is inclined can also be combined with the feature that at least one carrier roller 27 of the roller table 26 is equipped with a motorized drive.

According to another variant of the conveyor system 25, it includes a support 21, which may be provided on a carriage 20. Such a support 21 is shown in a very simplified way in FIG. 6, for example in the form of rods 21, which can be attached to the side of the carriage 20. The support 21, may also for example be a rod, hitch, hitch pin, lift pin, king pin, pin hook, etc.

The purpose of the above-mentioned support 21 is to be brought into interaction with a crate 24 located on the conveyor system 25. For example, the rods 21 of the support shown in FIG. 6 can be telescopically and vertically extended upwards and thus interact specifically with a crate located on the conveyor system 25. In this case, thanks to the interaction with the support 21, such a crate 24 is then moved or carried along the truss 12 with a movement of the carriage 24, in the same way as the carriage 20, to which the support 21 is attached.

In FIG. 8, the support 21, for example in the form of the above-mentioned rods that can be extended vertically in a telescopic manner and can thus be brought into interaction with a crate 24, is also greatly simplified and symbolically shown on the sides of a carriage 20.

By retracting the telescopic rods in a targeted manner, it is possible to again cancel an interaction between the support 21 and at least one crate 24, if necessary. In this case, a carriage 20, to which the support 21 is attached, can then be moved along the longitudinal extension of the truss 12 without the support 21 moving or dragging along a crate 24.

If the invention is equipped with a support 21 as explained above, this has the advantage that for moving crates 24 along a longitudinal extension of the truss 12 further drives for the roller table 26 of the conveyor system 25 are dispensable. This means, for example, that all rollers of the roller table can be passive, i.e., without drive, because the desired movement of at least one crate 24, preferably a plurality of such crates 24, can be realized only by the support 21.

The conveyor system 25 explained above, whether in the form of a conveyor belt system or a roller table 26, thus ensures that at least one crate 24, preferably a plurality of such crates 24, can always be moved to a predetermined position of the truss 12 in which an interaction with a cultivator 18, 19 attached to a robotic arm 23 is then possible.

A first sensor 30 can be attached to the stationary central column 14 at an upper end of it.

The assembly 10 may have a reservoir for water, fertilizer or the like adjacent to the stationary central column 14. In this respect, it is also possible to connect a water tank to an external pump in order to replenish the water reservoir with fresh water and thus to ensure the continuous operation of the assembly 10.

The above-mentioned reservoir can be mounted on the truss 12 so that it is moved around the stationary central column 14 together with the truss 12.

The assembly 10 may also be equipped with its own pump. With such a pump, it is possible to convey water or liquid fertilizer from the said water reservoir in the direction of the cultivators in the form of nozzles, which can be used for targeted irrigation and/or fertilization of plants.

By means of the first sensor 30 it is possible to monitor selected areas of an agricultural area N and/or a position of the truss 12 relative to the stationary central column 14. In this respect, the first sensor 30 within the meaning of the present invention is also referred to as a global sensor.

At least one cultivator 18 can be provided with a second sensor 32 (cf. FIG. 6, FIG. 16). The purpose of this second sensor 32 is to detect an area or space of an agricultural area immediately adjacent to or below this cultivator 18 in order to obtain information regarding the plants that are planted on the agricultural area N. In this respect, the first sensor in the sense of the present invention is also referred to as the local sensor.

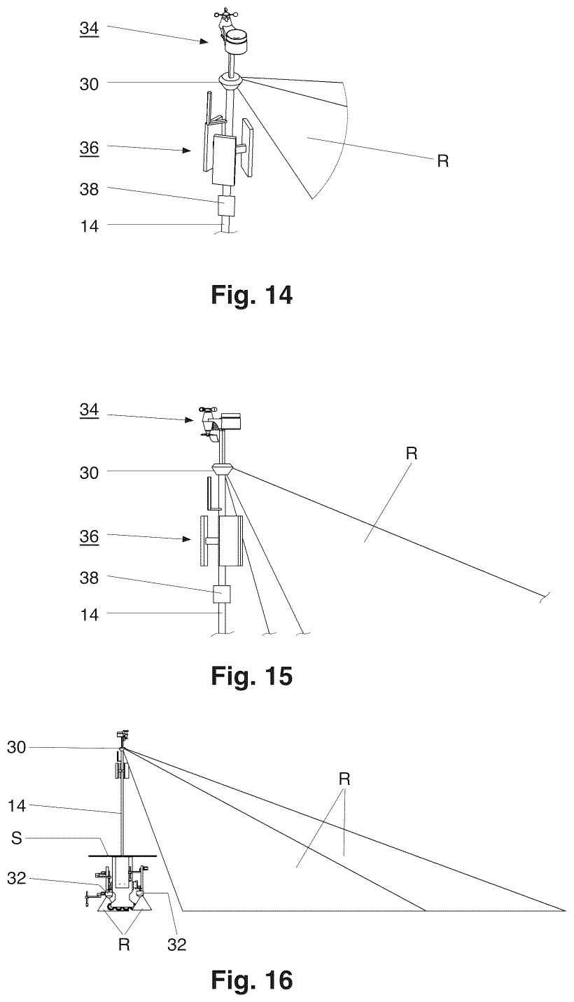

The areas captured by the first sensor 30 and the second sensor 32, respectively, are drawn with “R” in the drawing (cf. FIG. 2, FIG. 3, FIG. 5, FIG. 6, FIG. 11, FIGS. 14-16, FIG. 19) and can be understood according to the invention as monitoring space. This means that the sensors 30, 32 can be used to detect not only a flat surface (e.g., the ground of an agricultural area N), but also the space above it. Correspondingly, the position of the truss 12, the respective cultivators 18 attached to it, and of plants P and, for example, their growth and/or shaping.

A transmitter/receiver unit 36 and/or a weather station 34 may be attached to an upper area of the stationary central column 14. This is illustrated in the perspective view of FIG. 2 as well as in the side views shown in FIG. 14+15.

Furthermore, the assembly 10 of the invention also includes a control or adjustment apparatus 38, which can also be attached to the stationary central column 14 and which is greatly simplified in FIG. 14 and FIG. 15, respectively, in the form of a rectangle. This control and regulating apparatus 38 is connected by signal to the sensors 30, 32 and the transmitter/receiver unit 36.

By means of the control and regulating apparatus 38, it is possible to control the circular movement of the truss 12 around the stationary central column 14 and/or the operations or movements of the individual cultivators 18. This can also be done in the form of a control loop, i.e., in a regulated manner.

By means of the transmitter/receiver unit 36, information can be transmitted to or received by the assembly 10 of the invention from a remote control station, wherein this information provides data for the operation of the inventive assembly 10 or for carrying out a method of the present invention. For example, according to the invention, this information may contain target data for the operation of the assembly 10 and the equipment attached to it, wherein the control of the individual equipment and/or a movement of the truss 12 in a circular manner around the stationary central column 14 can also be regulated.

In the same way, by means of the transmitter/receiver unit 36, information obtained from the sensors 30, 32 with regard to the monitoring areas R captured by them can then be transmitted to a remote control station for further evaluation of the operation of the assembly 10 according to the invention.

FIG. 11 illustrates the use of the present invention in point management of an agricultural area N, also referred to as spot farming. As explained above, the monitoring area, which is detected by the second sensor 32, is drawn with “R”. The plants P, which are located in this monitoring area R, can thus be captured or detected by the sensor 32, wherein this information can then be transmitted to the control and regulating apparatus 38.

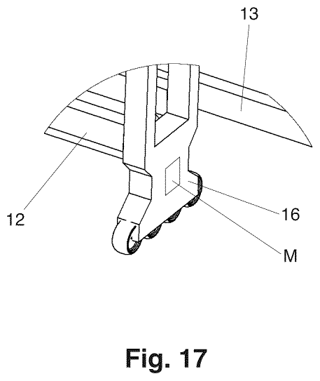

FIG. 17 shows a chassis 16 provided at one end of the truss 12. Such a chassis 16 may be equipped with an engine which drives at least one wheel of the chassis 16. Due to the contact of this driven wheel with the ground surface underneath, a torque is generated around the stationary central column 14 for the truss 12, in such a way that the truss 12 is set in a circular motion around the tripod 14 in a desired direction. In FIG. 17 the motor is marked “M” and symbolized only by a rectangle for simplicity.

A resulting circular track, which results from a movement of the truss 12 around the stationary central column 14, is designated “F” in FIG. 5.

In deviation from the illustration shown in FIG. 17, the chassis 16 can be designed as a tracked chassis instead of a chassis with wheels.

It may also be provided to design the chassis 16 with a running track or as a rail system, wherein the wheels do not roll on the natural arable land, but instead on a track arranged on the arable land.

Both of the above-mentioned variants for the chassis 16 have the advantage in common that the inventive assembly 10, when used on an agricultural area N in the open air, is less susceptible to rain and thus improves weather independence.

The inventive assembly 10 comprises at least one basic terminal 29 (cf. FIG. 4), which is provided to be adjacent to the stationary central column 14. The purpose of this base terminal 29 is to provide the necessary field logistics. This means that, by means of this base terminal 29, it is possible, for example, to provide or distribute seeds and/or to receive or pick up harvested crops, preferably through the use of the crates 24 already mentioned above.

The basic terminal 29 is shown in a very simplified way in the side view of FIG. 4. In order not to hinder a complete and permanent rotation of the truss 12 around the stationary central column 14 in the same direction, it can be provided that the base terminal 28 is effectively connected to the truss 12 and arranged on the opposite side of the tripod 14. This is shown in FIG. 4 by dashed lines. This means that when the truss 12 is rotated around the stationary central column 14, the base terminal 29 is also rotated. Depending on the size and weight of the base terminal 29, it may be equipped with castors or wheels on the underside that are in contact with the ground surface and roll on it.

As an alternative to the meaning of a base terminal, the reference sign 29 in FIG. 4 can also refer to a logistics vehicle which, for example, is used to deliver seed to the truss 12 and/or to market directly to the customer (delivery service). In the latter case, this means that the crates 24 filled with crops are loaded onto this logistics vehicle 29 and transported to the end customer without any further stops.

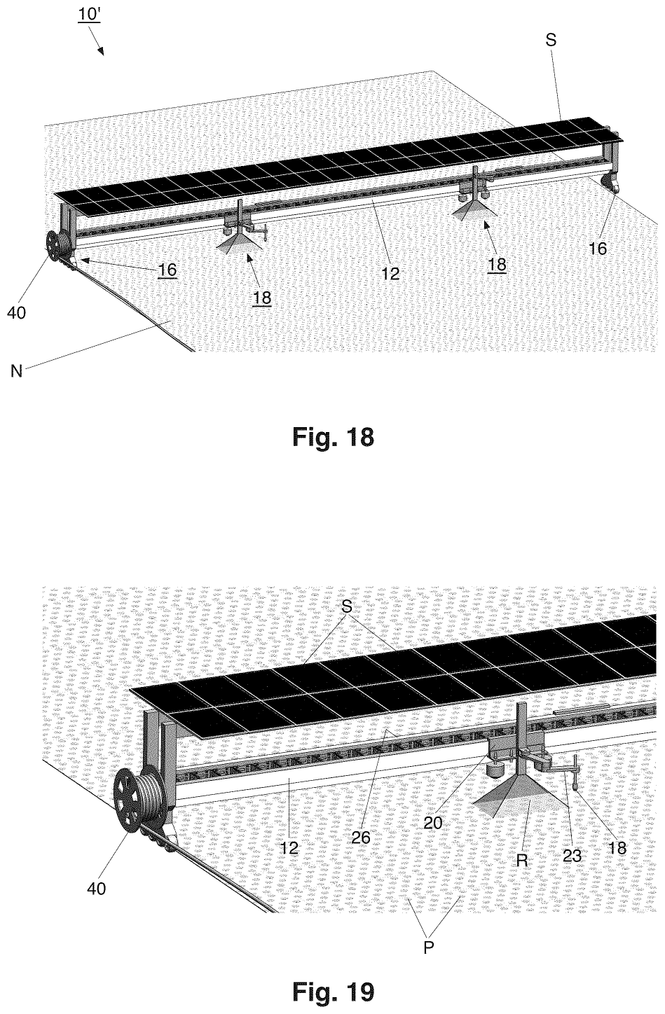

FIGS. 18 and 19 show an assembly 10′ that includes a truss 12, to each end of which a chassis 16 with wheels is attached. This means that the assembly 10′ and the associated truss 12 can be moved in a longitudinal direction or a linear manner over an agricultural area N.

At least one wheel of the chassis 16 can be equipped or at least coupled with a motor. Preferably, several wheels of the chassis 16 are equipped with a motorized drive, suitably on both sides of the elongated truss 12.

According to an example, the assembly 10′ according to FIG. 18 and FIG. 19, respectively, the chassis, which is provided at both ends of the truss 12, is each equipped with wheels which can be swiveled about a vertical axis of rotation. This makes it possible for the truss 12 to be moved over the ground of an agricultural area to be managed in an omnidirectional manner.

For the purposes of the present invention, the feature omnidirectional refers to movability or mobility in any desired direction. This means that, in addition to a purely linear or translational movement, there is also a diagonal driving, i.e., in a diagonal direction, and/or turning on the spot and/or driving in circles is possible. This applies both to the above-mentioned assembly 10′ and in the same way to a platform 101 of an inventive system, which will be explained separately below.

A cable reel 40 can be attached to one side of the truss 12. This cable reel 40 can be used to connect the respective supply lines for electricity and/or media for the management of the useful area N (e.g., water, fertilizer). Accordingly, it is possible to supply the truss 12 of the assembly 10′ with electricity, water and/or fertilizer by means of such a cable reel 40 and the associated supply lines.

In the assembly 10′, a plurality of cultivators 18 is also provided on the truss 12, preferably on both sides of it. The operation of these cultivators 18 and any possible control by the control or adjustment apparatus 38 is carried out in the same way as in the assembly 10, so that reference may be made to the above explanations in order to avoid repetition.

Furthermore, it may be pointed out that the assembly 10′ according to FIGS. 18, 19 can also be equipped with a conveyor system 25 in the form of a roller table 26. Targeted movement of at least one crate 24, preferably a plurality of such crates 24, on the roller table 26 and thus along the truss 12 can be achieved by having at least one carrier roller 27 of the roller table 26 be equipped with a motorized drive and/or that an inclination of the roller table 26 is set relative to the horizontal H. In order to avoid repetition, reference is made in this regard to the explanations to FIGS. 12 and 13, which, mutatis mutandis, are also applicable to FIG. 18 to FIG. 19.

For the supply of electrical energy, the inventive assembly 10, 10′ may be equipped with at least one battery storage B. According to the illustration of FIG. 8, this battery storage apparatus B can be installed in a lower area of the stationary central column 14. In any case, this battery storage apparatus B serves the purpose of supplying energy or electricity to the various apparatuses of the system.

In the assembly 10, 10′, a plurality of solar panels S can be arranged at a top of the truss 12 (cf. FIG. 2; FIGS. 18+19). These solar panels S are electrically connected to the battery storage B and are used to charge this battery storage B with the electrical energy obtained from solar radiation. In this way, a self-sufficient power supply is guaranteed for the invention.

The solar panels S can be appropriately dimensioned in such a way that the conveyor system 25 and the crates 24 picked up or transported in it are shielded from above, for example against precipitation or the ingress of dust and dirt. This is illustrated, for example, in the illustrations of FIGS. 2, 3, 5, 18 and 19.

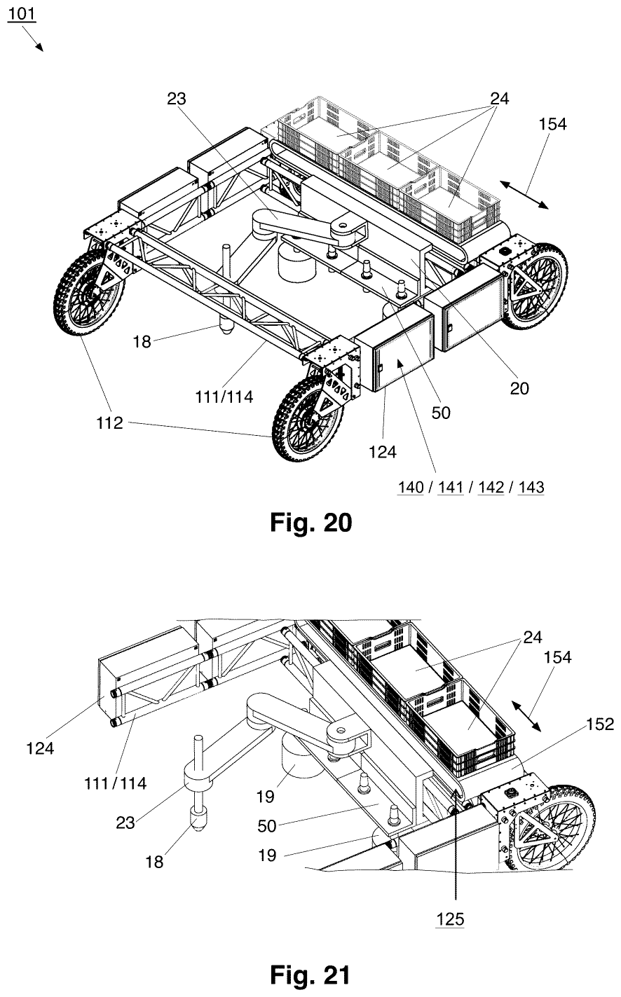

With reference to FIGS. 20-24, various examples of an inventive system 100 and its associated components are shown and explained below, by means of which an agricultural area N can be managed.

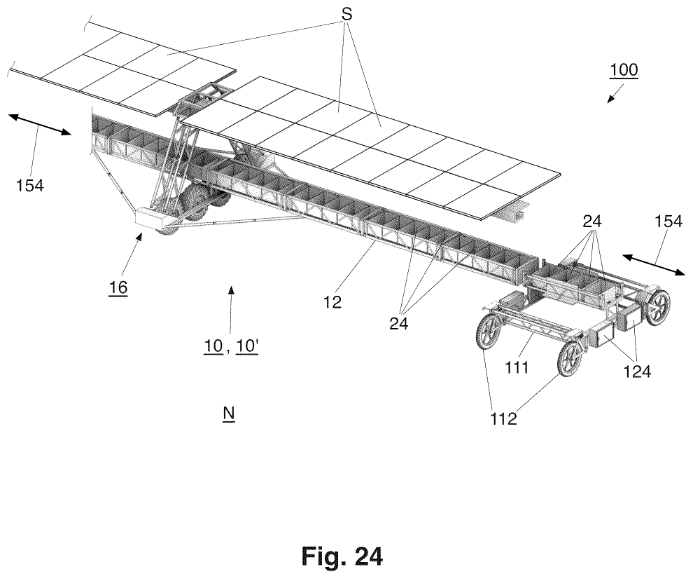

In such a system 100 (see FIG. 24), an assembly 10, 10′ is used, which is shown and explained above with reference to FIGS. 1-19. With regard to the inventive system 100, this

assembly 10, 10′ functions as a base station on an agricultural area N, as explained in detail below.

The inventive system 100 comprises at least one platform 101, 101′ with at least one cultivator 18, 19 connected to a chassis 111 of the platform 101, 101′ or part thereof, and which can be used to carry out at least one crop management process step.

With regard to the above-mentioned platform 101, 101′, it may also be pointed out that a cultivator 18, 19 may be mounted on the corresponding chassis 111 on a carriage 20, if necessary using a robotic arm 23. In this respect, such an attachment of a cultivator 18, 19 corresponds to that of FIG. 6, with reference being made to the explanations to FIG. 6 in order to avoid repetition.

The chassis 111 of the platform 101, 101′ or part thereof is fitted with a conveyor system 125 (see FIG. 21) with which at least one crate 24 can be moved longitudinally and/or transversely to the chassis 111 and thus moved to a predetermined position, in particular adjacent to a cultivator 18, 19.

In the context of the system 100 according to the invention, an essential feature is that the platform 101, 101′ can be placed in such a position adjacent to the truss 12 of the assembly 10; 10′ that the platform 101, 101′ can take over 24 crates from the truss 12, or such crates 24, which are then filled with crops from plants P and are located on the platform, can be returned to or onto the truss 12.

FIGS. 20 and 21 show the said platform 101 according to a first variant.

In the first variant, as shown in FIG. 20, the platform 101 is part of a mobile field robot, wherein a plurality of wheels 112 are attached to a chassis 111 thereof, with which the field robot 101 can be moved over the arable area N. For the purposes of the following discussion, the platform 101 is also referred to as mobile field robot 101 in accordance with this first variant.

At least one wheel 112 of the mobile field robot 101 is mounted so as to swivel or rotate about a vertical axis on the chassis 111 in order to enable the mobile field robot 101 to change its direction of travel.

The chassis 111 of the field robot 101 has a modular design. The chassis 111 can include a plurality of elongated and, in particular, tubular plug-in elements 114, which are connected or attached to an L-shaped base body 115 in the corner areas of the chassis 111.

The plug-in elements 114, which, as explained above, are part of the chassis 111 of the field robot 101, are known, for example, from event technology and can be designed as a 1-point truss or as a multi-point truss. In the example shown in FIGS. 20, 21, these plug-in elements 114 are each designed as 2-point truss.

The said plug-in elements 114 of the chassis 111 are characterized in that they can be connected to each other and again from each other without the use of special tools, in such a way that at least one dimension of the chassis can be changed quickly and easily. Such a variable dimension of the chassis 111 can be adjusted transversely and/or longitudinally to its longitudinal axis, and/or in its vertical axis, i.e., in a vertical direction.

A total of four wheels 112 are attached to the chassis 111 of the field robot 101. The above-mentioned L-shaped base bodies 115 are used to support the wheels 112. Accordingly, these L-shaped base bodies 115 each fulfil the function of a wheel suspension element.

In the assembled state of the field robot 101, the individual base bodies 115, which are used to support the respective wheels 112, and the plurality of the plug elements 114, which are attached to the base bodies 115 by profile elements 13, are thus components of chassis 111.

With regard to the wheels 112 of the field robot 101, it should be pointed out that for at least two such wheels it may be provided for them to be able to be swiveled about a vertical axis of rotation. This makes it possible for these wheels 112 to be swiveled relative to the base body 115 in order to achieve a change of direction for the mobile field robot 101 when it is moved over a substrate or ground.

If all four wheels 112 of the field robot 101 can be swiveled about a vertical axis of rotation, the field robot 101 can also be moved from a specific position in any direction, in particular on an agricultural area N, without restricting its mobility in the form of a turning circle. This ensures omnidirectional mobility of the field robot 101. With regard to the feature omnidirectional, reference should be made to the explanation already given above in order to avoid repetition.

At least one wheel 112 of the mobile field robot 101 can be equipped with an (unspecified) motor, such as a wheel hub motor. Preferably, several wheels 112 of the field robot 101 are equipped with such a motor drive.

As shown in FIGS. 20 and 21, two crate elements 124 are attached on each long side of the chassis 111 of the field robot 101. In this regard, it may be provided that such a crate element 124 is connected to a plug-in element 114 at suitable fastening points.

For the field robot 101 shown, the crate elements 124 are used for the purpose of receiver or attaching equipment elements therein that are important for the operation of the field robot 101. These equipment elements may be: a battery, or a plurality of such batteries; sensors, e.g., in the form of cameras; electrical and/or electronic components, e.g., in the form of a control or adjustment apparatus; an applicator or a cultivator 18, 19 with which a crop management process step can be carried out; and/or GPS sensors.

In the illustration of FIG. 20, it is symbolized by corresponding reference signs that a transmitter/receiver unit 140, a weather station 141, a control or adjustment apparatus 142 and/or a battery 143 can be included in a crate element 124.

With regard to the feature of a battery 143, it may be pointed out that for the present invention a battery that can be recharged in a known way is also meant here.

The attachment of a crate element 124 to a plug-in element 114, in relation to the assembled state of the chassis 111, is preferably carried out on the outside thereof. This allows for good accessibility for the crate elements 124, for example for maintenance or repair purposes.

In the case of the mobile field robot 101, it is possible to mount a cultivator 18, 19 on it, as has already been shown and explained in FIGS. 6 and 7. FIGS. 20, 21 show the field robot 101 in a representation when a cultivator 18 is attached to the chassis 111 of the field robot 101 by means of a robotic arm 23 and an associated carriage 20.

In addition to or as an alternative to the illustrations shown in FIGS. 20 and 21, it may be pointed out at this point that a cultivator 19, 19 may also be mounted on the outside of the chassis 111. Several cultivators 18, 19 can also be mounted on several sides of the chassis 111, in particular using carriages 20, for example on opposite sides of the chassis 111.

In the context of a cultivator 18, 19, as shown and explained with regard to FIGS. 6 and 7, it may also be pointed out at this point that a cultivator 18, 19 can be mounted in the same way on the truss 12 of the assembly 10, 10′ according to FIGS. 1-19 as on the mobile field robot 101 according to FIGS. 20, 21. Against this background, the advantage for a cultivator 18, 19 of the invention is that, in respect of the assembly 10, 10′ on the one hand and the field robot 101 on the other, it is possible to use the same parts and—if necessary—also the same spare parts for this purpose.

The illustrations shown in FIG. 21 demonstrate that the field robot 101 is also equipped with a conveyor system 125, which is attached to the chassis 111 or a part thereof. In the example shown here, this conveyor system 25 is mounted on an upper side of two base bodies 115.

The conveyor system 125 can be equipped with a circulating conveyor belt 152 in the mobile field robot 101 and serves the purpose of moving at least one crate 24 or a plurality of such crates 24 in the longitudinal or transverse direction of the chassis 111, thus being moved to a predetermined position, in particular adjacent to a cultivator 18, 19 mounted on the field robot 101. In this context, it goes without saying that a plurality of such crates 24 can be placed on top of the conveyor belt 152.

The conveyor belt 152 is suitably made of a rubberized material or has such a rubberized material on its surface. This has the advantage that it prevents a crate 24 from slipping on the conveyor belt 152.

The directions of movement that can be realized for the crates 24 with the conveyor system 125 and its conveyor belt 152 are symbolized in FIG. 21 by a double arrow and marked 154.

As an alternative to the conveyor belt 152 shown, the conveyor system 125 in the field robot 101 can also be equipped with a roller table with a plurality of carrier rollers, each with a horizontal axis of rotation, as is also the case with the truss 12 of the assembly 10, 10′ in FIGS. 1-19. For this purpose, one or more crates 24 can be placed on top of the roller table in the same way as for the conveyor belt 152. With regard to such a roller table, for example with regard to its drive, reference should be made to the explanation with respect to the inventive assembly 10, 10′ in order to avoid repetition.

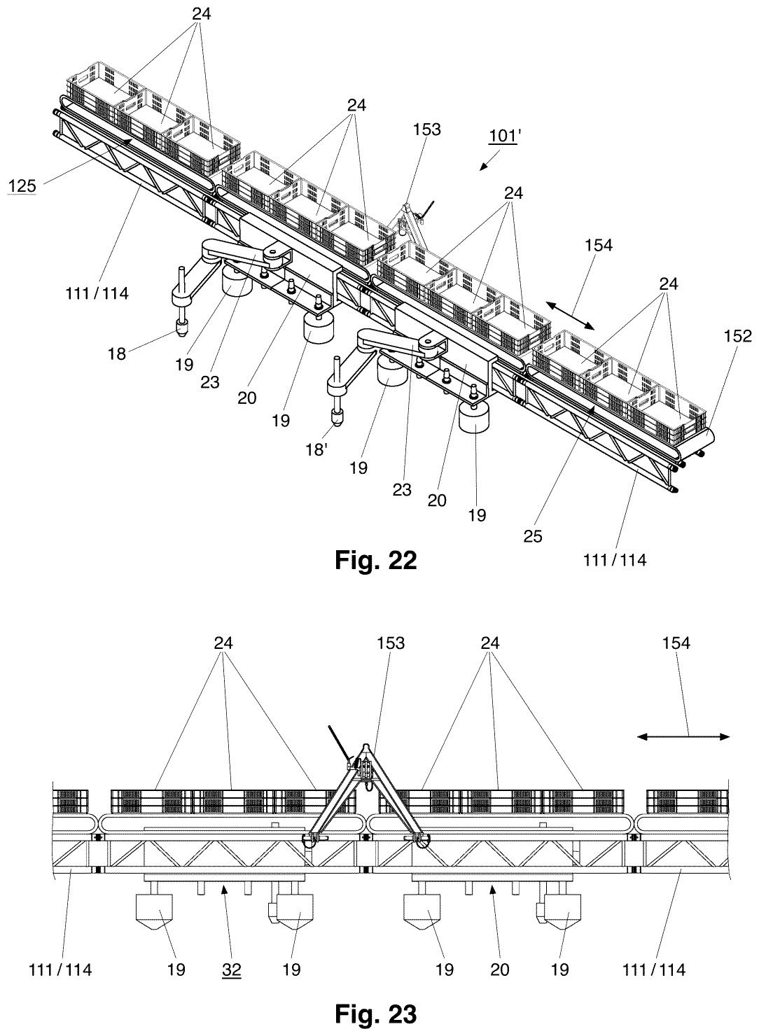

FIGS. 22 and 23 show the said platform 101′, which is part of the inventive system 100, according to a second variant, namely in FIG. 22 in a perspective view, and in FIG. 23 in a side view thereof.

According to the second variant of the platform 101′, its chassis 111 is equipped with a coupling device 153 with which the chassis 111 can be attached or hitched to a tractor or a comparable pulling machine. This coupling device 153 is suitably adapted to a three-point hitch of a tractor and can therefore be attached to such a three-point hitch.

In the same way as the first variant according to FIG. 20 and FIG. 21, the second variant of the platform 101′ according to FIG. 22 and FIG. 23 is modular with its chassis 111 and comprises a plurality of elongated and in particular tubular plug-in elements 114, which in particular can be connected to each other and removed from each other without the use of special tools. This makes it possible for at least one dimension of the chassis 111 to be changed. Preferably, this variable dimension of the chassis 111 is its length, which is perpendicular to the direction of travel of the tractor. In addition to or as an alternative, the variable dimension of the chassis may also be a width of the chassis 111 running in the direction of travel of the tractor and/or a height of the chassis 111 in a vertical direction.

In the case of the second variant of the platform 101′, which, as explained above, can be attached or hitched to a tractor or the like, as shown in FIG. 22, four plug-in elements 114 are mounted next to each other, i.e., in series. In the central area of the chassis 111 thus formed, i.e., between the second and third plug-in element 114, this platform 101′ comprises a coupling device 153 (see FIG. 23), which is adapted to a three-point hitch such as those used by tractors or similar machines. Accordingly, with the aid of this coupling device 153 it is possible to mount the platform 101′ on a three-point hitch, for example of a tractor.

Furthermore, in the case of the platform 101′ according to the said second variant in a central area of the chassis 111, two carriages 20 are provided in conjunction with associated robotic arms 23 and cultivators 18 attached to each of them.

In an upper part of the platform 101′ according to the second variant, namely on an upper side of the chassis 111 and the associated plug-in elements 114, a conveyor system 125 with a circulating conveyor belt 152 is arranged in the same way as in the assembly 10, 10′ and in the mobile field robot 101. Accordingly, crates 24, when placed on the conveyor belt 152, are moved in the two directions symbolized in FIG. 22 by a double arrow 154.

With regard to the functioning of a cultivator 18 and the conveyor system 125, which are included in the platform 101′ according to the second variant mentioned above, it is emphasized here that their operation and advantages are similar to those of the assembly 10, 10′ and the mobile field robot 101, respectively, and that in this respect reference may be made to the previous explanations in order to avoid repetition.

The perspective view of FIG. 24 now shows the inventive system 100, in which the assembly 10 (or the assembly 10′) and the mobile field robot 101 interact with each other. In the illustration of FIG. 24, for the sake of simplicity, the assembly 10, 10′, which can be an example according to FIGS. 1-19, is shown generally simplified and only in part.

In the context of the inventive system 100, the assembly 10, 10′ functions as a base station on an agricultural area N. In the sense of the present invention, this means that, on the one hand, it is possible to transfer crates 24 to the mobile field robot 101 in a targeted manner by means of this assembly 10. For this purpose, as shown in FIG. 24, the mobile field robot 101 can be positioned at one end face of the truss 12 in such a way that the operation of the conveyor system 25 can be used to transfer at least one of the crates 24, preferably from a plurality of such crates 24, from the truss 12 to the field robot 101. These crates 24 can be provided from the storage or roller magazine of the assembly 10 (or from the roller table 26 of the conveyor system 25).

For example, the crates 24 received by the field robot 101 by the truss 12 of the assembly 10, as explained, may be empty crates 24 or crates 24 containing seed, which is then transported to or sown on an agricultural area N by the mobile field robot 101 and a cultivator 8, 19 mounted on it.

After the field robot 101, as explained, has received at least one crate 24, preferably a plurality of such crates 24, from the truss 12 of the assembly 10, it can again move away from the assembly 10 and go about its work independently or autonomously. In this context, it is pointed out that the method of the invention cannot only be carried out by the assembly 10, 10′, but also by the mobile field robot 101 described here.

For the inventive system 100, it is further pointed out that the mobile field robot 101, if after the execution of crop management process steps, crop from plants P have been placed into the crates 24 which are located on the field robot 101, is again moved to a position adjacent to an end face of the truss 12 of the assembly 10, as shown in FIG. 24. This is then done for the purpose of returning the crates 24 filled with crops by the field robot 101 to the truss 12 of the assembly 10, so that these crates can reach the storage or roller magazine of the assembly 10 (or the roller table 26) via the conveyor system 25 of the assembly 10. This is followed by further handling of these crates 24 filled with crops, for example loading onto transport vehicles, as already explained in connection with FIG. 4.

As explained above, at least one conveyor system may be provided for both the assembly 10, 10′ and the mobile field robot 101. If necessary, according to their second variant, the assembly 10, 10′ and/or the mobile field robot 101 or the platform 101′ can each be equipped with a plurality of such conveyor systems, which can then be arranged vertically on top of each other and/or horizontally next to each other. In any case, such a conveyor system 25, 125 ensures that at least one crate 24, preferably a plurality of such crates 24, is always placed at a predetermined position of the truss 12 of the assembly 10, 10′ or the chassis 111 of the field robot 101, in which position an interaction with a cultivator 18, 19 attached to a robotic arm 23 is then possible. For the purposes of the present invention, such an interaction can be understood that either things are deliberately removed from a crate 24 by a cultivator 18, 19, for example seed, seedlings, young plants or the like, or that a cultivator 18, 19 is used to deliberately place harvested crops in a crate 24 in the course of a harvesting process step. As mentioned elsewhere, as explained above, this crop may come from different plants or varieties, namely in the event that there is a mixed cultivation of plants or vegetables on the agricultural area N. With the present invention it is thus possible to place crops of different plants P in a common crate 24 provided for this purpose.

If, in the course of harvesting, the crates 24, which are located on the conveyor system 25 of the assembly 10, 10′ or the platform 101, 101′, are completely filled with crops, the invention may provide that this level is detected by suitable sensors. In this case, in relation to the assembly 10, these full crates 24 can be moved by means of the conveyor system 25 to a position of the storage or roller magazine (or the roller table 26) where the filled crates 24 can be transferred to transport vehicles, for example for further processing or logistics. In relation to the mobile field robot 101, in this case (i.e., when recognizing filled crates 24), the field robot 101 is moved back to the end face of the truss 12 of the assembly 10, 10′, as explained, so that a return of filled crates 24 located on the field robot 101 can be returned to the truss 12 of the assembly 10, 10′. Thus, the assembly 10, 10′ fulfills or takes over the function of a base station. The same applies to a platform 101′ according to the second variant, which is attached to a tractor.

Following this, it is then possible for empty crates 24 to be provided (again) on the roller table 26 of the conveyor system 25 and/or transferred again to the mobile field robot 101 from the said storage or roller magazine of the conveyor system 25 (or the roller table 26), so that further crop management process steps can be carried out by the assembly 10, 10′ and/or by the platform (e.g., as a mobile field robot 101).

The above explanation of the system 100 of the invention, which is given for the example of the use of a platform of the first variant in the form of the mobile field robot 101, also applies, mutatis mutandis, to the second variant of the platform 101′, which is attached to a tractor or the like. In connection with the fact that this platform 101′ can be moved to a position adjacent to the truss 12 at which it is possible to transfer crates 24 from the truss 12 to or onto the platform 101′ or to receive crates filled with crops on the truss 12 from the direction of the platform 101′, it should be understood with regard to the platform 101′ according to the second variant that this is achieved by moving the tractor, to which the platform 101′ is attached or hitched according to the second variant, to this said position adjacent to the truss 12 of the assembly 10, 10′.

Finally, in relation to the system 100 of the invention, it is emphasized that this can also be equipped with a plurality of platforms 101, 101′. This means that a number of mobile field robots 101 can then be used, each of which can be moved, preferably alternately, to a position adjacent to the truss 12 in order to receive crates 24 there from the truss 12 or to hand them over to the truss 12. The same applies to a number of different platforms 101′ according to the second variant, which may be attached to different tractors or the like.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An assembly for management of an agricultural area, the assembly comprising:
at least one elongated truss and an associated chassis with at least one wheel with which the truss is adapted to be moved in a circular or linear manner over arable land;
at least one cultivator that is movable or displaceable along the truss;
at least one crate; and
a plurality of carriages arranged on the truss, the plurality of carriages being attached to associated guide rails of the truss and being movable along the truss in a direction of a longitudinal extension of the truss, at least one cultivator being attached to each carriage and thus the carriages serve as tool carriers for a cultivator; and
a conveyor system arranged on the truss along the longitudinal extension,
wherein the at least one crate is adapted to be moved with the conveyor system along the longitudinal extension of the truss in a certain direction and thus to a predetermined position adjacent to the at least one cultivator,
wherein at the same time different types of cultivators are mounted on at least one carriage and thus the carriage serves as a tool carrier for these different types of cultivators, and
wherein a plurality of carriages is provided with at least one attached cultivator on opposite sides of the truss.

2. The assembly according to claim 1, wherein the truss or the conveyor system is equipped with a storage or roller magazine in which a plurality of crates are accommodated, or wherein at least 10, 20, or 50 crates are accommodated in the storage or roller magazine.

3. The assembly according to claim 1, wherein the conveyor system has a roller table with a plurality of carrier rollers, each with a horizontal axis of rotation, and wherein at least one crate is adapted to be placed on the carrier rollers of the roller table.

4. The assembly according to claim 3, wherein the roller table also has a plurality of guide rollers, each with a vertical axis of rotation, and wherein the guide rollers are each arranged on the side of the roller table and limit the roller table to the side.

5. The assembly according to claim 3, wherein at least one roller of the roller table is motor-driven in order to transport the crate in a desired direction along the truss.

6. The assembly according to claim 3, wherein at least one of the carrier rollers is motor-driven.

7. The assembly according to claim 1, wherein the plurality of carriages with the cultivators attached to them can be moved independently of each other.

8. The assembly according to claim 1, wherein the conveyor system has a support that is adapted to be brought into interaction with the crate in order to move the crate along the longitudinal extension of the truss in a certain direction, and wherein at least one carriage, on which the support is provided, is adapted to be moved along a longitudinal extension of the truss and is provided on associated guide rails of the truss.

9. The assembly according to claim 1, further comprising a tool change system that is mounted or provided on the truss, wherein a plurality of different cultivators are adapted to be attached or mounted on or in the tool change system and, wherein, on at least one robotic arm, at least one cultivator is interchangeable with another cultivator or the tool change system is attached to an associated guide rail of the truss and is movable along the truss in the direction of the longitudinal extension.

10. The assembly according to claim 1, further comprising a control or adjustment apparatus via which a movement of the truss over the arable area and/or an actuation of at least one cultivator is controlled or adjusted, wherein a transmitter/receiver is signally connected to the control and adjustment apparatus and is used to either receive and/or transmit information or data packets for monitoring and/or control of the operation of the truss and/or cultivators attached to it or provided there from a remote location or from a control station, and wherein the transmitter/receiver is attached to the truss.

11. A method for management of an agricultural area, the method being carried out fully automatically and includes associated crop management process steps of planting or sowing the plants until they are harvested, the method comprising:
placing a predetermined quantity of harvested crops mechanically in a crate that is provided for this purpose in a course of harvesting;
sowing or harvesting, on the same agricultural area, different plants in the form of mixed management, wherein plant management and harvesting processes are mapped as pick-and-place processes, and the pick-and-place processes are carried out across crops for different species and sizes of vegetable plants,
placing together, when the harvest is brought in, the harvested crop from different plants in a common crate via a cultivator;
performing spot farming on the agricultural area, in which the management of the arable area only focuses on targeted planting points where plants are introduced into the ground, the targeted planting points being used for sowing the plants, irrigating and/or harvesting the mature plants; and
providing an assembly according to claim 1.

12. The method according to claim 11, wherein non-edible biomass from the plants to be harvested is separated by a cultivator of the assembly, wherein the separation of non-edible biomass takes place at a stage of the plant while it is still attached to the agricultural area, wherein a separation of non-edible plants takes place in the course of a process step when the plant is removed from the ground, wherein, a cutting of plants and/or separation of non-edible biomass is supported by an optical sensor fitted to a cultivator or an associated carriage of the assembly, thereby detecting the plant and its position and/or size.

13. The method according to claim 11, wherein the agricultural area with different varieties of plants and vegetables is managed and includes iceberg, butterhead and romaine lettuce, red cabbage and white cabbage (mini), broccoli, kohlrabi, celery, cucumbers, zucchini and/or pumpkin, so that a mixed management of plants or vegetables takes place on the agricultural area.

14. The method according to claim 11, wherein the method is performed with the assembly.

15. The method according to claim 11, wherein the method is carried out using at least one platform which is movable relative to the agricultural area with at least one cultivator attached to a chassis of the platform or part thereof, and with which at least one crop management process step is carried out, wherein a conveyor system is attached to the chassis of the platform or part thereof, via which at least one crate is moved longitudinally and/or transversely of the chassis of the platform and thus placed in a predetermined position or adjacent to a cultivator.

16. The method according to claim 15, wherein the platform adjacent to the truss of the assembly is brought into a position such that crates are transferred back either from the truss to the platform or from the platform to the truss.

17. A system for management of an agricultural area, the system comprising:
an assembly according to claim 1, which fulfils the function of a base station on an agricultural area; and
at least one platform movable relative to the agricultural area, the at least one platform being provided separately from the assembly and comprises at least one cultivator attached to a chassis of the platform or part thereof, with which a crop management process step is carried out,
wherein the chassis of the platform or part thereof is fitted with a conveyor system to transport at least one crate that is moveable in a longitudinal and/or transverse direction of the chassis to a predetermined position or to a cultivator,
wherein the platform is placed in a position adjacent to the truss of the assembly such that the platform is adapted to receive crates from the truss or return to the truss such crates that are filled with crops of plants and are on the platform,
wherein the platform is part of a mobile field robot comprising a plurality of wheels attached to a chassis of the mobile field robot, which is adapted to be moved over the arable area,
wherein at least one of the wheels is provided equipped with a drive, and
wherein at least one wheel is mounted about a vertical axis on the chassis so as to swivel or rotate to allow for the mobile field robot to change a direction of travel.

18. The system according to claim 17, wherein the chassis of the platform is modular and comprises a plurality of elongated and tubular plug-in elements, wherein the plug-in elements are connectable to each other and are adapted to be separated from each other without the use of special tools such that at least one dimension of the chassis is variable.

19. The system according to claim 17, wherein, in relation to the platform, at least one carriage is attached to associated guide rails of the chassis, which is movable along a longitudinal extension of the platform, and wherein at least one cultivator is attached to the carriage and thus the carriage (20) serves as a tool carrier for a cultivator.

20. The system according to claim 17, wherein the conveyor system has a support that is brought into interaction with a crate in order to move the crate along the longitudinal extension of the platform in a specific direction, and wherein, on associated guide rails of the platform, at least one movable crate is attached, on which the support is provided.
